(19) United States
(12) Patent Application Publication
(10) Pub. No.: US 2011/0017025 A1
(43) Pub. Date: Jan. 27, 2011

(54) Diesel Injector Pressure Regulator Socket

(76) Inventor: Tim Firzlaff, Mankato, MN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/507,121

(22) Filed: Jul. 22, 2009

(51) Int. Cl. B25B 13/06

(52) U.S. Cl. 81/121.1

(57) ABSTRACT

A socket for an injector pressure regulator having an upper and a lower portion that forms a body. The socket is configured to remove or install the injection pressure regulator in an engine, such as a Ford diesel engine. The socket further includes a tapered portion and a driver receiving portion to receive a driver of a wrench. A slot is formed in the upper and lower portions to better mate with the injector pressure regulator. The inner portion of the socket includes a dome portion that provides a space between the socket and a top of the injector.

### FIELD OF THE INVENTION

The present invention relates generally to a socket. More particularly, the present invention relates to a diesel injector pressure regulator socket for use in a vehicle.

### BACKGROUND OF THE INVENTION

Given the soaring price of gasoline, diesel engines are becoming more prevalent in vehicles. Within a diesel engine is an injection pressure regulator (IPR) that regulates the high oil pressure in the engine and tailor the injection characteristics of the injector. The IPR typically does not need replacing but may need to be replaced when it sticks if debris enters the valve or if the o-ring fails. Diesel engines are continuously updated and various sockets are needed to service them. Accordingly, it is desirable to provide a socket that fits the various IPR available on the vehicle.

### SUMMARY OF THE INVENTION

The foregoing needs are met, to a great extent, by the present invention, wherein in one aspect an apparatus is provided that in some embodiments a universal socket is provided that includes an upper portion and a lower portion configured to remove and replace an injector pressure regulator.

In accordance with one embodiment of the present invention, a socket adapted for an injector pressure regulator is provided, which can include a body having an upper portion with a first diameter and a lower portion with a second diameter, a slot formed in a side wall of body, a top surface of the upper portion having a wrench driver receiving portion and a third diameter, a mating portion that mates with a portion of the injector pressure regulator, the mating portion being positioned in the lower portion, and a dome within an inner portion of the body, wherein the dome partially defines a bottom portion of the wrench driver receiving portion, the dome provides a space between the socket and a top portion of the injector pressure regulator.

In accordance with another embodiment of the present invention, a socket adapted for an injector pressure regulator is provided, which can include a receiving means having an upper portion with a first diameter and a lower portion with a second diameter, a slot means formed in a side wall of the receiving means, a top surface of the upper portion having a driver receiving means and a third diameter, a mating means that mates with a portion of the injector pressure regulator, the mating means being positioned in the lower portion, and a dome within an inner portion of the receiving means, wherein the dome partially defines a bottom portion of the driver receiving means, the dome provides a space between the socket and a top portion of the injector pressure regulator.

In accordance with yet another embodiment of the present invention, a method of removing an injector pressure regulator is provided that includes attaching a driver of a wrench into a driver receiving slot of a socket, placing the socket over the injector pressure regulator, mating a mating portion of the socket to a complementary portion of the injector pressure regulator, creating a space between a dome of the socket with a top portion of the injector pressure regulator, and rotating the socket with the driver of the wrench to remove the injector pressure regulator.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings.

The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a socket according to an embodiment of the invention.

FIG. 2 illustrates is a cross section view A-A of the socket in of FIG. 1.

### DETAILED DESCRIPTION

The invention will now be described with reference to the drawing figures, in which like reference numerals refer to like parts throughout. An embodiment in accordance with the present invention provides a socket that fits the majority of IPRs in existence and IPRs recently introduced.

An embodiment of the present invention includes a socket 100 to remove the IPR from an engine and replace the IPR in the engine. The engine may be a Ford 6.0L diesel engine. This engine has been around for a number of years and was recently updated with a new IPR that is different in dimensions than previous generations of the IPR. Thus, the updated IPR requires a technician to have various sockets on hand to remove and replace the Ford 6.0L's IPR depending on the built date of the engine. Having to determine the correct sized sockets to use will increase the repair time of the IPR leading to additional costs to the customer. Further costs are added to the garage by having to carry more than one socket to service a particular IPR.

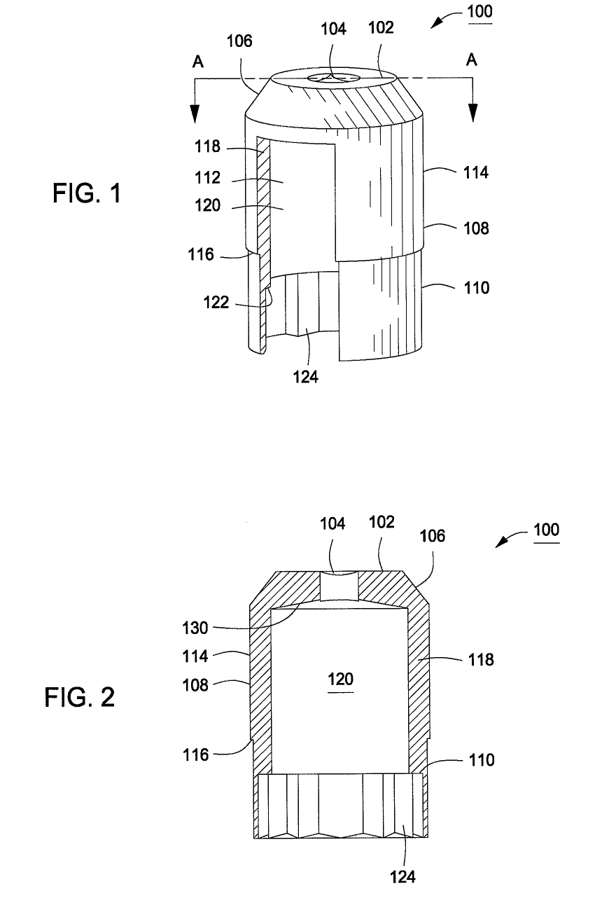

FIG. 1 illustrates a socket 100 according to an embodiment of the invention. The socket 100 can include an upper portion 108 and a lower portion 110 that are integral to each other and form a body 114. In another embodiment, the upper and lower portions 108, 110 are not integral to each other but are friction fitted, welded, glued or otherwise held together. The socket can be made of any material such as aluminum, metal, steel, such as chrome vanadium steel and other suitable material. The socket can be cast from a mold or machined. A coating such as black oxide may be used to coat the socket to prevent damage or rusting. However, any coating can be used to coat the socket.

The socket 100 may have a length from about 67.00 to about 70.00 mm in one embodiment and in another embodiment from about 67.83 to about 69.33 mm. The length or height of the socket allows the socket 100 to fit into tight applications where other sockets will not fit (because they are too short, for example). The socket 100 may in one embodiment have an overall body diameter from about 42.00 to about 45 mm. In another embodiment, the lower portion's outer diameter is about 42.55 to about 43.05 mm and the upper portion's outer diameter is about 44.45 mm. The outer diameter of the socket 100 allows the socket to work and fit on certain year range applications when other sockets (smaller or larger diameter sockets, for example) will not fit. In another embodiment, the outer diameter of the body 114 is uniform and in still another embodiment, the outer diameter of the body 114 is uniform, but for a tapered portion, discussed below.

The upper portion 108 includes a first surface 102, which is flat and is positioned on an end of the upper portion. The diameter of the first surface may be about 31.00 to about 33 mm in one embodiment and in another embodiment may be about 31.37 to about 32.13 mm. The first surface 102 is flat so that it can mate with a flat surface of a socket driver of a wrench (not shown). However, the first surface may also be contoured as desired so long as it can mate with the surface of the socket driver. The first surface also includes a socket hole 104 to mate with the socket driver of the wrench. The socket hole 104 shown is a square socket hole 104 but the hole can be any size and configuration as desired, such as being triangular, diamond, or rectangular shaped. The upper portion 108 includes a tapered portion 106 that tapers from the first surface to the rest of body 114. Thus, the outer diameter of the first surface 102 is smaller than the outer diameter of the body 114, as discussed above. The taper portion 106 helps to reduce the cost of producing the socket 100.

The body 114 includes a slot 112 that allows the socket 100 to slide around the IPR's connector fitting and remove and install the IPR where a prior art socket did not fit. The slot 112 is located within the upper and lower portions 108, 110 of the body 114. In one embodiment, a width of the slot 112 is from about 22.00 to about 24 mm and in another embodiment from about 22.25 mm to about 23.75 mm. The length of the slot 112 in one embodiment is about 55.00 to 57 mm and in another embodiment about 55.50 to about 56.50 mm. However, the slot 112 can be any size and shape as desired to fit around the IPR.

The body 114 includes an internal width portion 118, which is thicker in the upper portion 108 than in the lower portion 110. A width step 122 is formed by the difference in the internal width portion 118. Similarly, a body step 116 is formed on the outer surface of the body 114 because the upper portion's outer diameter is wider than the lower portion's outer diameter, as discussed above.

An inner wall 120 of the body 114 is generally smooth and has a constant inner diameter. The internal height of the socket in one embodiment is from about 58 to about 61 mm and in another embodiment from about 58.5 to about 60.5 mm. The internal height allows the socket 100 to fit over the IPR and allow for removal and installation of the IPR. However, at a lower portion of the inner wall, the diameter changes where an IPR mating portion 124 is present. The IPR mating portion 124 may be double hex shaped to mate with a complementary portion of the IPR to be removed. The “12 point” socket design allows the socket to be easily aligned over the IPR for quick removal and installation on certain year range vehicles. In another embodiment, a hex socket or any other socket design can also be used.

FIG. 2 illustrates is a cross section view A-A of the socket 100 in of FIG. 1. The socket 100 is shown with the upper portion 108 and lower portion 110. The internal width portion 118 is thicker at the upper portion than in the lower portion. Further in this view, the inner portion of the socket includes a dome 130. The dome 130 defines a bottom portion of the socket hole 104. The dome is formed in the inner portion of the tapered portion 106 and is positioned next to the inner wall.

In one embodiment, the dome can be shaped so that it can mate to a top portion of the IPR being installed or removed. In another embodiment, the dome can be designed to provide a space between the socket and the top portion of the IPR. However, any shape (convex, concave, etc.) can be contemplated as being part of the invention.

In operation, the socket driver of the wrench is inserted into the socket hole of the socket. The socket is placed over the injector pressure regulator so that the socket's mating portion can mate with the complementary portion of the injector pressure regulator to be removed. Once the socket is in place, the wrench can be used to rotate the socket to either remove or insert the injector pressure regulator.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A socket adapted for an injector pressure regulator, comprising:
a body having an upper portion with a first diameter and a lower portion with a second diameter;
a slot formed in a side wall of body;
a top surface of the upper portion having a wrench driver receiving portion and a third diameter;
a mating portion that mates with a portion of the injector pressure regulator, the mating portion being positioned in the lower portion; and
a dome within an inner portion of the body, wherein the dome partially defines a bottom portion of the wrench driver receiving portion, the dome provides a space between the socket and a top portion of the injector pressure regulator.

2. The socket of claim 1, wherein the first diameter of the upper portion is larger than the second diameter of the lower portion.

3. The socket of claim 1, wherein the third diameter of the top surface is smaller than the second diameter of the lower portion.

4. The socket of claim 1, wherein a step is formed between the first diameter of the upper portion and the second diameter of the lower portion.

5. The socket of claim 1, wherein the dome mates with an inner wall of the body.

6. The socket of claim 5, wherein a tapered portion is formed between the top surface and the upper portion.

7. The socket of claim 6, wherein the dome is formed within the tapered portion of the upper portion.

8. The socket of claim 1, wherein the mating portion is double hex.

9. The socket of claim 1, wherein the slot is configured to receive a portion of the injector pressure regulator's connector.

10. The socket of claim 1, wherein the socket has a length from about 67 to about 70.00 mm.

11. The socket of claim 1, wherein the upper portion's outer diameter is about 44.45 mm.

12. A socket adapted for an injector pressure regulator, comprising:
a receiving means having an upper portion with a first diameter and a lower portion with a second diameter;
a slot means formed in a side wall of the receiving means;
a top surface of the upper portion having a driver receiving means and a third diameter;
a mating means that mates with a portion of the injector pressure regulator, the mating means being positioned in the lower portion; and
a dome within an inner portion of the receiving means, wherein the dome partially defines a bottom portion of the driver receiving means, the dome provides a space between the socket and a top portion of the injector pressure regulator.

13. The socket of claim 12, wherein the first diameter of the upper portion is larger than the second diameter of the lower portion.

14. The socket of claim 12, wherein the third diameter of the top surface is smaller than the second diameter of the lower portion.

15. The socket of claim 12, wherein a step is formed between the first diameter of the upper portion and the second diameter of the lower portion.

16. The socket of claim 12, wherein the dome mates with an inner wall of the body.

17. The socket of claim 16, wherein a tapered portion is formed between the top surface and the upper portion.

18. The socket of claim 17, wherein the dome is formed within the tapered portion of the upper portion.

19. The socket of claim 12, wherein the mating means is double hex.

20. The socket of claim 12, wherein the slot is configured to receive a portion of the injector pressure regulator's connector.

21. A method of removing an injector pressure regulator, comprising:
attaching a driver of a wrench into a driver receiving slot of a socket;
placing the socket over the injector pressure regulator;
mating a mating portion of the socket to a complementary portion of the injector pressure regulator;
creating a space between a dome of the socket with a top portion of the injector pressure regulator; and
rotating the socket with the driver of the wrench to remove the injector pressure regulator.
